(19) United States
(12) Patent Application Publication
(10) Pub. No.: US 2015/0206733 A1
(43) Pub. Date: Jul. 23, 2015

(54) TECHNIQUES FOR PERFORMING MASS SPECTROMETRY

(71) Applicant: Waters Technologies Corporation, Milford, MA (US)

(72) Inventor: James P. Murphy, Franklin, MA (US)

(21) Appl. No.: 14/425,124

(22) PCT Filed: Sep. 6, 2013
(86) PCT No.: PCT/US13/58483

§ 371 Date: Mar. 2, 2015

Related U.S. Application Data
(60) Provisional application No. 61/697,990, filed on Sep. 7, 2012.

(51) Int. Cl. H01J 49/26; B01D 59/44

(52) U.S. Cl. CPC H01J 49/26; B01D 59/44

(57) ABSTRACT

Techniques are described for performing mass spectrometry. A quadrupole, or more generally, an electrode-based device, performs mass filtering for selectively filtering ions. One or more components generate a first RF potential, a DC potential, and a supplemental RF potential applied to the quadrupole. The supplemental RF potential has a corresponding multiple notched waveform having a plurality of corresponding frequencies thereby allowing a plurality of ions to pass through the quadrupole at a same time. Each of the plurality of corresponding frequencies corresponds to a notch in the waveform allowing one of the plurality of ions of a different mass or m/z to pass through the quadrupole for processing by another component or device.

### CROSS REFERENCE TO RELATED APPLICATIONS

This application is a National Stage of International Application No. PCT/US2013/058483, filed Sep. 6, 2013, which claims the benefit of U.S. Provisional Application No. 61/697,990, filed Sep. 7, 2012, TECHNIQUES FOR PERFORMING MASS SPECTROMETRY, all of which are incorporated by reference herein.

### TECHNICAL FIELD

This application generally relates to techniques for use with analyses of compounds, and, more particularly, to instruments and methods for performing mass spectrometry.

### BACKGROUND INFORMATION

Mass spectrometry (MS) is used widely for identifying and quantifying molecular species in a sample. During analysis, molecules from the sample are ionized to form ions. A detector produces a signal relating to the mass of the molecule and charge carried on the molecule and a mass-to-charge ratio (m/z) for each of the ions is determined.

A chromatographic separation technique may be performed prior to injecting the sample into a mass spectrometer. Chromatography is a technique for separating compounds, such as those held in solution, where the compounds will exhibit different affinity for a separation medium in contact with the solution. As the solution flows through such an immobile medium, the compounds separate from one another. Common chromatographic separation instruments include gas chromatographs (GC) and liquid chromatographs (LC). When coupled to a mass spectrometer, the resulting systems are referred to as GC/MS or LC/MS systems. GC/MS or LC/MS systems are typically on-line systems in which the output of the GC or LC is coupled directly to the MS.

In an LC/MS system, a sample is injected into the liquid chromatograph at a particular time. The liquid chromatograph causes the sample to elute over time resulting in an eluent that exits the liquid chromatograph. The eluent exiting the liquid chromatograph is continuously introduced into the ionization source of the mass spectrometer. As the separation progresses, the composition of the mass spectrum generated by the MS evolves and reflects the changing composition of the eluent.

Typically, at regularly spaced time intervals, a computer-based system samples and records the spectrum. The response (or intensity) of an ion is the height or area of the peak as may be seen in the spectrum. The spectra generated by conventional LC/MS systems may be further analyzed. Mass or mass-to-charge ratio estimates for an ion are derived through examination of a spectrum that contains the ion. Retention time estimates for an ion are derived by examination of a chromatogram that contains the ion.

Two stages of mass analysis (MS/MS also referred to as tandem mass spectrometry) may also be performed. One particular mode of MS/MS is known as product ion scanning where parent or precursor ions of a particular m/z value are selected in the first stage of mass analysis by a first mass filter/analyzer. The selected precursor ions are then passed to a collision cell where they are fragmented to produce product or fragment ions. The product or fragment ions are then mass analyzed by a second mass filter/analyzer.

### SUMMARY OF THE INVENTION

In accordance with one aspect of the invention is an apparatus for performing mass spectrometry comprising a quadrupole that performs mass filtering for selectively filtering ions; and one or more components that generate a first RF potential, a DC potential, and a supplemental RF potential applied to the quadrupole. The supplemental RF potential has a corresponding multiple notched waveform having a plurality of corresponding frequencies thereby allowing a plurality of ions to pass through the quadrupole at a same time. Each of the plurality of corresponding frequencies corresponds to a notch in the waveform allowing one of the plurality of ions of a different mass or m/z to pass through the quadrupole for processing by another component. The mass spectrometer may comprise three quadrupoles and the quadrupole may be a first of the three quadrupoles coupled to a second of the quadrupoles. The second quadrupole may fragment at least a portion of selected ions that pass through/are emitted from the first quadrupole, and the second quadrupole may emit fragment ions. The second quadrupole may be coupled to a third of the three quadrupoles, and wherein the third quadrupole may perform mass filtering for selectively filtering fragment ions emitted from the second quadrupole. The apparatus may further include one or more components that generate a second RF potential, a second DC potential, and a second supplemental RF potential applied to the third quadrupole. The second supplemental RF potential may have a corresponding multiple notched waveform having a plurality of corresponding frequencies thereby allowing a plurality of the fragment ions to pass through the third quadrupole at a same time. Each of the plurality of corresponding frequencies may correspond to a notch in the waveform allowing one of the plurality of fragment ions of a different mass or m/z to pass through the third quadrupole for processing by another component. The quadrupole may filter fragmented ions received from an upstream component. Each of the corresponding frequencies may correspond to a notch in the waveform allowing a different one of the fragmented ions of a different mass or m/z to pass through the quadrupole. The DC potential may be zero. For a plurality of scans taken at a plurality of points in time, for each of the plurality of scans, the first RF potential may have an amplitude that drives the quadrupole and may be held at a constant frequency, the DC potential amplitude may be held at zero, and amplitude of the first RF potential may be varied. The plurality of ions may pass through pass the quadrupole in a single scan.

In accordance with another aspect of the invention is an apparatus for performing mass spectrometry comprising: an electrode-based device that performs mass filtering of ions; and one or more components that generate a first RF potential, a DC potential, and a supplemental RF potential applied to said electrode-based device. The supplemental RF potential may have a corresponding multiple notched waveform having a plurality of corresponding frequencies thereby allowing a plurality of ions to pass through the electrode-based device at a same time. Each of the plurality of corresponding frequencies may correspond to a notch in the waveform allowing one of the plurality of ions of a different mass or m/z to selectively pass through the electrode-based device for subsequent processing by another component. The electrode-based device may be any of multi-pole device and a quadrupole device. The DC potential may be zero. The plurality of ions may be selected fragmented ions and the electrode-based device may perform filtering to allow the selected fragmented ions to pass through the electrode-based device to a detector. The selected fragments ions may be associated with a precursor ion selectively emitted by a second electrode-based device upstream from the electrode-based device. The apparatus may also include one or more components that generate a second RF potential, a second DC potential, and a second supplemental RF potential applied to the second electrode-based device. The second supplemental RF potential may have a corresponding multiple notched waveform having a plurality of corresponding frequencies thereby allowing a plurality of precursor ions to pass through the quadrupole at a same time. Each of the plurality of corresponding frequencies may correspond to a notch in the waveform allowing one of the plurality of precursor ions of a different mass or m/z to pass through the second electrode-based device for processing by another component.

In accordance with another aspect of the invention is a method of performing mass spectrometry comprising: performing first mass filtering of precursor ions using a first quadrupole to selectively allow a first precursor to pass through the first quadrupole for processing by second quadrupole; performing, using the second quadrupole, fragmentation of the first precursor ion emitted from the first quadrupole, the fragmentation producing a plurality of fragment ions associated with the first precursor ion; and performing second mass filtering using a third quadrupole to selectively allow at least two of the plurality of fragment ions to pass through the third quadrupole at a same time for a same scan. The third quadrupole may have applied thereto a first RF potential, a supplementary RF potential and a DC potential, wherein the DC potential is zero and the supplementary RF potential has a corresponding waveform comprising a plurality of notches therein. Each of the plurality of notches may correspond to a different frequency allowing a different one of the at least two fragment ions having a different mass or m/z than others of the at least two fragment ions to pass through the third quadrupole at a same time for a same scan.

In accordance with another aspect of the invention is a method for performing mass spectrometry comprising applying a first RF potential, a DC potential, and a supplemental RF potential to an electrode-based device of a mass spectrometer. The supplemental RF potential has a corresponding multiple notched waveform having a plurality of corresponding frequencies thereby allowing a plurality of ions to pass through the electrode-based device at a same time. Each of the plurality of corresponding frequencies corresponding to a notch in the waveform allowing one of the plurality of ions of a different mass or m/z to pass through the electrode-based device for processing by another component. The method also comprises performing mass filtering for selectively filtering ions using the electrode-based device. The mass spectrometer may be used to perform the mass spectrometry and may comprise three quadrupoles. The electrode-based device may be a first of the three quadrupoles coupled to a second of the quadrupoles. The second quadrupole may fragment at least a portion of selected ions that pass through/are emitted from the first quadrupole, and the second quadrupole may emit fragment ions. The second quadrupole may be coupled to a third of the three quadrupoles, and wherein the third quadrupole may perform mass filtering for selectively filtering fragment ions emitted from the second quadrupole. A second RF potential, a second DC potential, and a second supplemental RF potential may be applied to the third quadrupole. The second supplemental RF potential may have a corresponding multiple notched waveform having a plurality of corresponding frequencies thereby allowing a plurality of the fragment ions to pass through the third quadrupole at a same time. Each of the plurality of corresponding frequencies corresponding to a notch in the waveform allowing one of the plurality of fragment ions of a different mass or m/z to pass through the third quadrupole for processing by another component. The electrode-based device may be a multi-pole device that filters fragmented ions received from an upstream component or device. Each of the corresponding frequencies may correspond to a notch in the waveform allowing a different one of the fragmented ions of a different mass or m/z to pass through the electrode-based device. The DC potential may be zero. For a plurality of scans taken at a plurality of points in time, for each of the plurality of scans, the first RF potential may have an amplitude that drives the quadrupole and may be held at a constant frequency, the DC potential amplitude may be held at zero, and wherein amplitude of the first RF potential may be varied.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of an LC/MS system, in accordance with one embodiment of the invention;

FIGS. 2 and 3 are examples illustrating a quadrupole operating as a mass filter as may be used in an embodiment in accordance with techniques herein;

FIGS. 4, 5, and 6 illustrate a mass operating line or scan line and stability region as may be used in connection with a quadrupole acting as a mass filter;

FIG. 7 is an example of a notched waveform of a supplemental RF potential that may be used in an embodiment in accordance with techniques herein; and

FIGS. 8 and 9 illustrate exemplary uses of the techniques herein in an embodiment of a triple quadrupole mass spectrometer.

### DESCRIPTION

As used herein, the following terms generally refer to the indicated meanings:

“Chromatography”—refers to equipment and/or methods used in the separation of chemical compounds. Chromatographic equipment typically moves fluids and/or ions under pressure and/or electrical and/or magnetic forces. The word “chromatogram,” depending on context, herein refers to data or a representation of data derived by chromatographic means. A chromatogram can include a set of data points, each of which is composed of two or more values; one of these values is often a chromatographic retention time value, and the remaining value(s) are typically associated with values of intensity or magnitude, which in turn correspond to quantities or concentrations of components of a sample. In connection with techniques herein, the sample may contain one or more compounds of interest. A sample or compound of interest may generally be, or include, any molecule including, for example, a small molecule, such as an organic compound, metabolite, and organic compounds, as well as a larger molecule such as a protein.

Retention time—in context, typically refers to the point in a chromatographic profile at which an entity reaches its maximum intensity.

Ions—A compound, for example, that is typically detected using the mass spectrometer (MS) appears in the form of ions in data generated as a result of performing an experiment such as in an LC/MS or GC/MS system. An ion has, for example, a retention time and an m/z value. The LC/MS or GC/MS system may be used to perform experiments and produce a variety of observed measurements for every detected ion. This includes: the mass-to-charge ratio (m/z), mass (m), the retention time, and the signal intensity of the ion, such as a number of ions counted. In following paragraphs and descriptions, reference may be made to a particular system and components including an MS, such as an LC/MS system, for purposes of illustration.

Generally, an LC/MS system may be used to perform sample analysis and may provide an empirical description of, for example, a protein or peptide as well as a small molecule such as a pharmaceutical or herbicide in terms of its mass, charge, retention time, and total intensity. When a molecule elutes from a chromatographic column, it elutes over a specific retention time period and reaches its maximum signal at a single retention time. After ionization and (possible) fragmentation, the compound appears as a related set of ions.

In an LC/MS separation, a molecule may produce a single or multiple charged states. MS/MS may also be referred to as tandem mass spectrometry which can be performed in combination with LC separation (e.g., denoted LC/MS/MS).

Techniques and embodiments will now be described with reference to exemplary methods and apparatus for analyzing samples such as may be for sample analyses in a system performing LC/MS/MS. It will be appreciated that the techniques described herein may be used in connection with other embodiments and have broader application for analysis than as described in connection with exemplary embodiments herein. For example, an embodiment may utilize the techniques herein when performing other separation processing (e.g., using GC rather than LC), use other suitable instruments different than those particular ones mentioned herein having the required capabilities and functionalities, and the like.

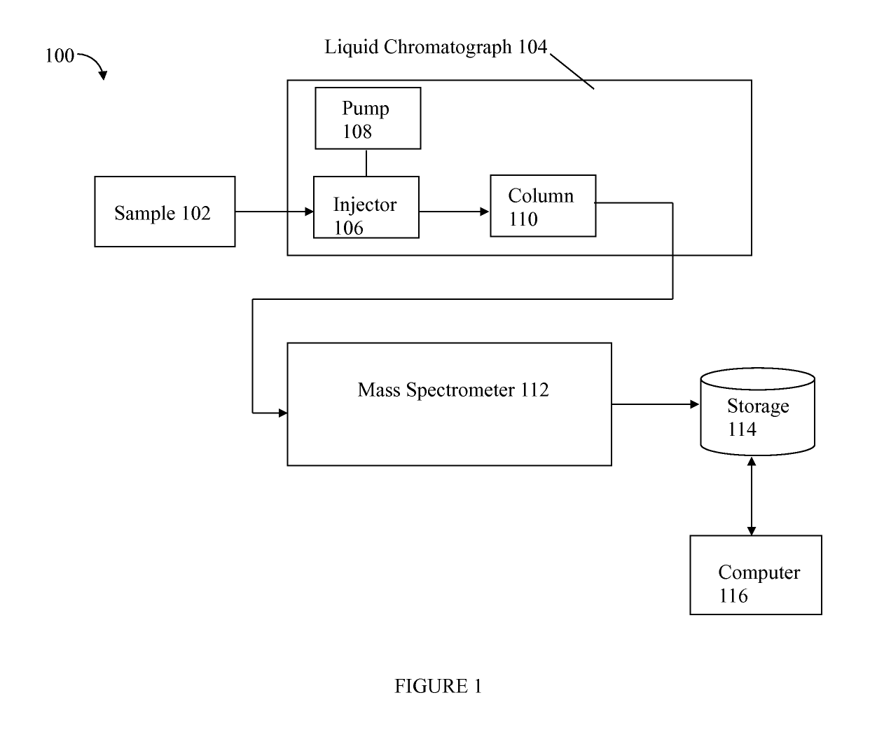

Referring to FIG. 1, shown is an embodiment of a system in accordance with techniques herein. The system 100 includes a liquid chromatograph (LC) 104, mass spectrometer (MS) 112, storage 114, and computer 116. As will be described in following paragraphs, the system 100 may be used to perform analysis of sample 102 for detecting one or more compounds of interest. The LC 104 may include an injector 106 that receives sample 102, a pump 108, and a column 110. The liquid sample 102 may be introduced as an input to the LC 104.

In operation, the sample 102 is injected into the LC 104 via the injector 106. The pump 108 pumps the sample through the column 110 to separate the sample into component parts according to retention time through the column 110. A high pressure stream of chromatographic solvent provided by pump 108 and injector 106 forces sample 102 to migrate through a chromatographic column 110 in liquid chromatograph 104. Column 110 typically comprises a packed column of silica beads whose surface comprises bonded molecules. The output from the column 110 is input to MS 112 for analysis. Although not illustrated in FIG. 1, the MS 112 may include components such as a desolvation/ionization device, collision cell, mass analyzer, a detector, and the like. In one embodiment, the LC 104 may be an ultra performance liquid chromatography (UPLC) system such as the ACQUITY UPLC® System from Waters Corporation of Milford, Mass.

Mass analyzers of the MS 112 can be placed in tandem in a variety of configurations, including, e.g., quadrupole mass analyzers. A tandem configuration enables on-line collision modification and analysis of an already mass-analyzed molecule. For example, in triple quadrupole based massed analyzers (such as Q1-Q2-Q3), the second quadrupole (Q2) imports accelerating voltages to the ions separated by the first quadrupole (Q1). These ions collide with a gas expressly introduced into Q2. The ions fragment as a result of these collisions. Those fragments are further analyzed by the third quadrupole (Q3).

As an output, the MS 112 generates a series of spectra or scans collected over time. A mass-to-charge spectrum is intensity plotted as a function of m/z. Each element, a single mass-to-charge ratio, of a spectrum may be referred to as a channel. Viewing a single channel over time provides a chromatogram for the corresponding mass-to-charge ratio. The generated mass-to-charge spectra or scans can be acquired and recorded on a storage medium such as a hard-disk drive or other storage media represented by element 114 that is accessible to computer 118. Typically, a spectrum or chromatogram is recorded as an array of values and stored on storage 114. The spectra stored on 114 may be accessed using the computer 116 such as for display, subsequent analysis, and the like. A control means (not shown) provides control signals for the various power supplies (not shown) which respectively provide the necessary operating potentials for the components of the system 100 such as the MS 112. These control signals determine the operating parameters of the instrument. The control means is typically controlled by signals from a computer or processor, such as the computer 116.

A molecular species migrates through column 110 and emerges, or elutes, from column 110 at a characteristic time. This characteristic time commonly is referred to as the molecule's retention time. Once the molecule elutes from column 106, it can be conveyed to the MS 112. A retention time is a characteristic time. That is, a molecule that elutes from a column at retention time t in reality elutes over a period of time that is essentially centered at time t. The elution profile over the time period is referred to as a chromatographic peak. The elution profile of a chromatographic peak can be described by a bell-shaped curve. The peak's bell shape has a width that typically is described by its full width at half height, or half-maximum (FWHM). The molecule's retention time is the time of the apex of the peak's elution profile. Spectral peaks appearing in spectra generated by mass spectrometers have a similar shape and can be characterized in a similar manner.

The storage 114 may be any one or more different types of computer storage media and/or devices. As will be appreciated by those skilled in the art, the storage 114 may be any type of computer-readable medium having any one of a variety of different forms including volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired code, data, and the like, which can accessed by a computer processor.

The computer 116 may be any commercially available or proprietary computer system, processor board, ASIC (application specific integrated circuit), or other component which includes a computer processor configured to execute code stored on a computer readable medium. The processor, when executing the code, may cause the computer system 116 to perform processing steps such as to access and analyze the data stored on storage 114. The computer system, processor board, and the like, may be more generally referred to as a computing device. The computing device may also include, or otherwise be configured to access, a computer readable medium, such as represented by 114, comprising executable code stored thereon which cause a computer processor to perform processing steps.

The system 100 may be used to perform LC/MS/MS on a sample and generate mass spectra for one or more precursors and/or product or fragment ions (generated from each of one or more of the foregoing precursors) of at least one compound in the sample. The generated mass spectra may be further analyzed and/or processed for use in connection with any of a variety of techniques for different applications. In connection with the techniques herein, the mass spectra data may be examined to determine a precursor and its associated product ions. Once the precursor and its associated product ions have been determined, such information may be used to identify a particular compound of interest, used in connection with confirming a presence of a compound in a sample, used in quantification of a compound, and the like. For example, information may be contained in a database for a compound of interest which is known and identified by the occurrence of a precursor and one or more product ions. The precursor and/or product ion information obtained from the mass spectra may be compared against a database of known precursor/product ion information for known compounds.

Different suitable methods may be used with the system 100 to obtain precursor and product ions from a sample injection. Such methods provide effectively simultaneous mass analysis of both precursor and product ions. For example, a portion of an eluted precursor is fragmented to form product ions, and the precursor and product ions are substantially simultaneously analyzed, either at the same time or, for example, in rapid succession. Depending on the experiment performed and operation of the MS 112, an embodiment may use retention-time observations to support the determination of which product ion(s) are derived from a particular precursor where the product ions are associated with their precursor ion in response to matching retention-time values.

Analysis of the mass spectra permits measurement of an accurate retention time value for both the eluted precursor and its associated product(s) or fragment(s). Moreover, for example, peak shape, width, and/or retention time of the peaks associated with precursor ions and with product ions may be compared to determine which product ions are associated with a particular precursor ion. The product ions are associated with their precursor ion in response to matching retention-time values and/or other characteristics such as chromatographic peak profile or shape as described elsewhere herein. Furthermore and more generally, ions (precursors and fragments) derived from a common originating molecule may have a common retention time and/or other similar characteristics.

For example, a threshold retention-time difference is selected; if the difference in retention times of a product ion and a precursor ion is less than the threshold value, the product is determined to be derived from the precursor. For example, one suitable threshold value is equal to one tenth the retention-time peak width of the precursor ion. The retention-time value of an ion is optionally defined as the time value of the peak maximum of the peak that was observed for that ion.

In an LC/MS experiment as mentioned above, an ion can be described and/or referred to by its retention time, mass-to-charge ratio or mass, charge state, and intensity. An originating molecule can give rise to multiple ions derived from the originating molecule where each such ion is either a precursor or a fragment. These fragments arise from processes that break up the originating molecule. These processes can occur in the ionization source or in a collision cell of the MS 112. Because fragment ions derive from a common eluting, originating molecule, they must have the same chromatographic retention time and peak profile as the originating molecule. The retention time and peak shapes of ions that derive from a common originating molecule are the same because the time of ion formation, fragmentation, and ion detection is generally much shorter than the peak width of the originating molecule. For example, a typical chromatographic peak width, measured at full-width at half-maximum (FWHM) is 5 to 30 seconds. The time of ion formation, fragmentation, and detection is typically sub milliseconds. Thus on a chromatographic time scale, the time of ion formation is an instantaneous process. It follows that differences in observed retention times of the ions that derived from an originating molecule is effectively zero. That is, sub-millisecond retention time differences between ions that derived from an originating molecule are small compared to the chromatographic peak width.

With respect to ions that are generated from collision-induced disassociation of intact precursor ions, the fragment or product ions are associated with their parent precursor ion. In connection with one technique using the MS 112, a single precursor ions may be selected for fragmentation, such as by the first mass analysis stage or quadrupole in a triple quadrupole and the selected precursor ion may be subsequently fragmented. Alternatively, more than one such precursor ion may be selected for subsequent fragmentation.

The retention time and chromatographic peak profile of a molecule (such as, for example, a small molecule, metabolite, natural product in connection with techniques herein) eluting from a chromatographic support matrix, such as column 110, is a function of the physical interaction of that molecule between the support matrix and mobile phase. The degree of interaction that a molecule has between the support matrix and the mobile phase dictates the chromatographic profile and retention time for that molecule. In a complex mixture, each molecule is chemically different. As a result, each molecule can have a different affinity for the chromatographic matrix and the mobile phase. Consequently, each can exhibit a unique chromatographic profile.

Generally, a chromatographic profile for a specific molecule is unique and describes the physicochemical properties of that molecule. Parameters optionally used to characterize the chromatographic peak profile of a given molecule include the time of initial detection (liftoff), normalized slope, the time of inflection points relative to the time of the peak apex, the time of maximum response (peak apex), the peak width, at inflection points, at full-width-at-half-maximum (FWHM), peak shape asymmetry, and the time of the final detection (touch down) to name only a few.

An eluting precursor passed to the mass spectrometer may be characterized as producing ions in both low- and elevated-energy modes. The ions produced in the low-energy mode are primarily those of the unfragmented precursor ions in possibly different isotopic and charge states. In elevated-energy mode, the ions are primarily different isotopes and charge states of the fragment, or product, ions of those precursors. High-energy mode can also be referred to as elevated-energy mode.

In connection with an embodiment in accordance with techniques herein, the MS 112 may be a triple quadrupole (TQ) mass spectrometer although the techniques herein may also be used with a single quadrupole mass spectrometer. In connection with techniques herein, a quadrupole may be used as a mass filter to selectively allow one or more ions having a particular mass to pass through the quadrupole. The selected ions passing through the quadrupole may be subsequently analyzed by a receiving downstream component or device. The quadrupole may utilize a combination of direct current (DC-time independent) and radio frequency (RF-time dependent) electric fields applied to the quadrupole structure as described below in more detail in connection with functioning as a mass filter in order to effect which m/z or mass values are filtered or otherwise allowed to pass through the quadrupole.

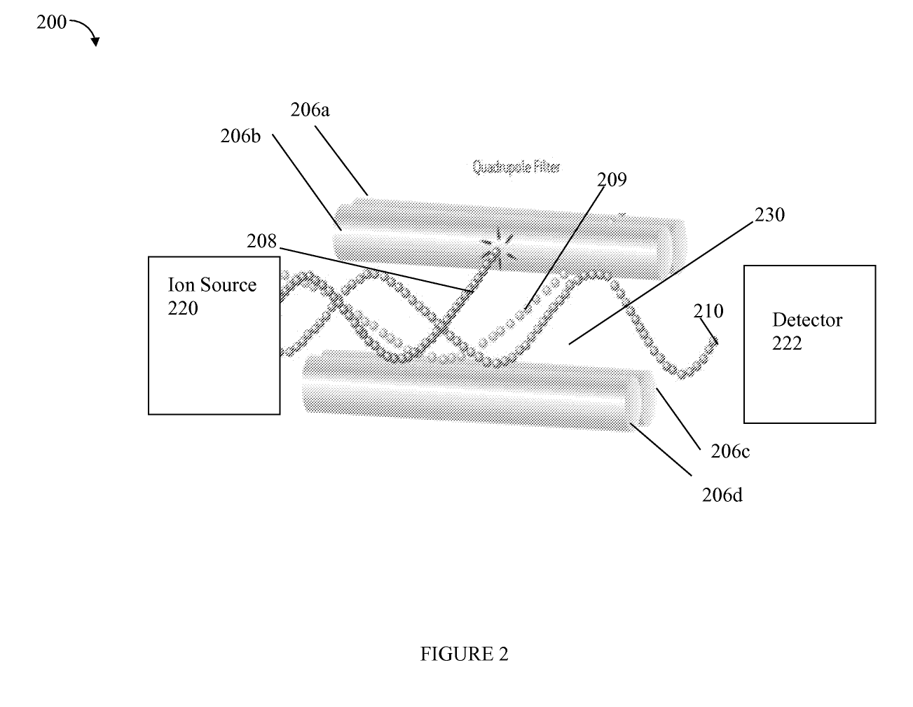

Referring to FIG. 2, shown is an example illustrating components that may be used in connection with a single quadrupole 200 that includes 4 longitudinally parallel round rods 206a-d. The arrangement in the example 200 provides for four parallel surfaces. To create suitable electric fields, opposing surfaces (those diagonally opposite one another such as 206a and 206d, and also 206b and 206c) may be electrically connected together and also to RF and DC power sources (not illustrated). Ions from an ion source 220 are accelerated into the space 230 comprising the quadrupole's electric field along the longitudinal axis of the rods. The combination of both RF and DC potentials applied to all 4 rods may be tuned to allow for ion selection so that one or more ions, each having a selected mass or m/z, are allowed to pass through the quadrupole space 230. Systematically changing the field strength such as by adjusting the RF and/or DC voltages alters which m/z or mass values are filtered (not allowed to pass through the quadrupole) or are otherwise transmitted through (allowed to pass through the quadrupole's space 230) at any point in time. The quadrupole may operate as a mass filter, also referred to as a quadrupole mass filter (QMF) based on the foregoing.

In operation, a mass spectrum is obtained using QMF by increasing or decreasing the magnitude of the RF amplitude and DC potentials at a fixed ratio (e.g., the DC and RF voltages may be ramped or scanned at a constant ratio and the resolution of the instrument is established by the ratio of RF to DC potentials. The RF frequency is held constant while the RF amplitude is varied along with the DC amplitude). Generally, the path of motion or trajectory of an ion through the area 230 varies with the energy imparted to the ion by the particular RF and DC settings. Thus, different ions pass through the quadrupole depending on the selected RF and DC settings. Ion trajectories though the central space 230 between the electrical poles are complex. For any given set of DC and RF potentials, only ions of a specific m/z or mass avoid collision with the rods and successfully traverse space 230 of the quadrupole filter. All other ions collide with the quadrupole surfaces at those values of the RF and DC potential. The entire mass spectrum may be scanned as the RF and DC potentials are varied from a minimum potential to a maximum potential (or vice versa) while also maintaining a constant DC/RF ratio. To further illustrate, the example 200 includes ions having trajectory paths 208, 209 and 210 for a selected RF amplitude and DC potential at a point in time. The trajectory paths reflect the motion of their respective ions through the quadrupole when particular RF and DC potentials are applied to the rods inducing an electric field in the area 230. Paths 208, 209 are those associated with ions that are filtered out or do not pass through the quadrupole. Path 210 illustrates a trajectory of an ion that is not filtered out and thereby allowed to pass through the quadrupole such as to reach detector 222.

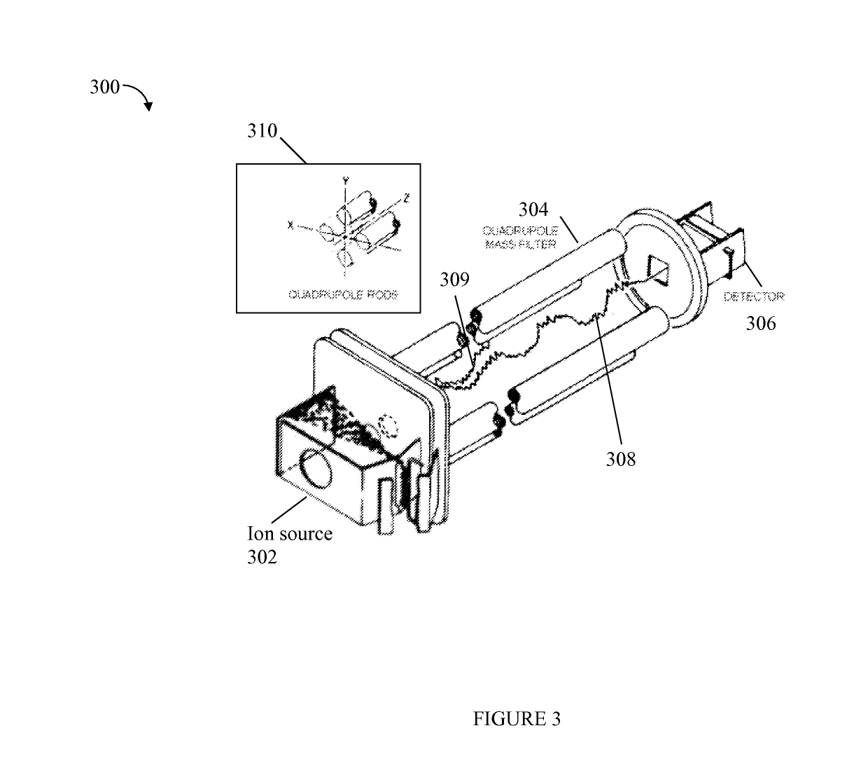

FIG. 3 is another exemplary illustration of a quadrupole such as described above in connection with FIG. 2. The example 300 illustrates a quadrupole mass filter 304 that filters ions generated by ion source 302 to selectively allow only ions having a particular mass or m/z value to reach detector 306. Elements 308, 309 illustrate ion trajectory paths where a first ion having path 308 of a first mass or m/z collides with the quadrupole rod surfaces and a second ion having path 309 of a second mass or m/z successfully traverses the quadrupole along the z-axis to reach the detector 306. Element 310 illustrates the x, y and z axes of the four rods in the example 304.

As described below in more detail, techniques herein may apply an additional supplemental RF potential or voltage to the surfaces of the 4 rods. The supplemental RF voltage signal may have a waveform characterized as a notched waveform containing a series of frequency-based notches allowing ions of different masses or m/z values to pass through the quadrupole at a single or same point in time. The waveform may contain multiple notches corresponding to multiple sets of one or more frequencies. Each of the notches, and associated one or more frequencies, may allow an ion of a different mass or m/z value to pass through the quadrupole. As will also be described below, in one embodiment using the techniques herein with the supplemental RF potential, the quadrupole may operate in an RF-only mode so that the DC potential or voltage is zero. In other words, one embodiment may operate the quadrupole for mass filtering by applying a first or primary RF potential at a fixed or constant frequency while varying the the amplitude of the first RF potential during operation, applying a DC potential or voltage of zero, and applying a supplemental RF potential having a notched waveform with a multiple frequency-based notches. Each of the foregoing notches may allow an ion of a different mass or m/z to pass through the quadrupole at the same time. By allowing multiple ions to pass through at the same time for a single MS scan using the notched waveform of the supplemental RF potential, the sensitivity of the single scan is increased.

It should be noted that in connection with a quadrupole in an embodiment in accordance with techniques herein, the rods may be made of any suitable material capable of generating the quadrupole electric field. Additionally, although the rods are illustrated as round rods, an embodiment may use rods of any suitable shape such as those have metal hyperbolic surfaces. Furthermore, depending on the material used for the rods and thereof ability to generate the desired electric field, the rods, or surfaces thereof, may be coated with a conducting material.

The techniques herein may be utilized in a mass spectrometer using only a single quadrupole as well as one including multiple quadrupoles. For example, a single quadrupole MS device may not be sufficient for identification techniques used with complex mixture analysis. It may be desirable to not only look at ion masses or m/z values since two ions may have the same mass or m/z, but in order to differentiate between detected ions, it may also be desirable to examine other characteristics of the ions. To this end, the techniques herein may also be used in connection with various operating modes of a triple quadrupole MS device to cause fragmentation of one or more precursor ions. In operation, the triple quadrupole MS may use the first quadrupole Q1 as a first mass filter to select a first precursor ion which pass through to the second quadruple Q2 which causes fragmentation of the precursor ion. Q2 may operate as a collision cell at an elevated or high energy causing generation of fragment or product ions from the first precursor ion. Thus, the originating sample or analyte may be identified, quantified, and the like, based on the foregoing precursor and its associated fragment or product ions. Therefore, one use of the techniques herein in an embodiment using a triple quadrupole MS may select a single precursor ion using Q1 and then utilize a Q3 having a supplemental RF potential with the notched waveform having a series of notches to selectively allow multiple fragments of the single precursor ion to pass through Q3 to a detector. By having Q3 allow multiple selected fragments to pass through (rather than just one fragment) at the same time in a single scan, the sensitivity of the scan of an associated experiment is increased. The foregoing and other modes of operation of the triple quadrupole MS in an embodiment in accordance with techniques herein are described elsewhere herein in more detail.

There are multiple physical variables that affect the instantaneous electric fields experienced by ions a quadrupole. For the classical hyperbolic mass filter, the potential distribution Φ at any time t is described by

Φ=[U+V Cos(ωt)]((x²−y²)/2r₀²) EQUATION A

where x and y are distances along the axes, r₀ is the distance from the z-axis in FIG. 3 to either of the quadrupole surfaces (e.g., radius of the quadrupolar field), ω is the angular frequency (2πf) of the applied AC or RF signal, V is the magnitude of the applied RF signal, and U is the magnitude of the DC potential applied to the rod surfaces. The instantaneous electric field along any of the x, y and z axis of FIG. 3 may be computed by taking the partial derivative of EQUATION A as a function of a desired one of the axis. The foregoing illustrates that the applied DC and RF potentials or voltages to the surfaces cause no acceleration on the ions in the z direction since there is no dependence in EQUATION A on z. Well-known parameters “a” and “q” based on Mathieu equations may be expressed in a simplified or reduced form where such parameters may be characterized as simple ratios of pertinent physical parameters summarizing the stability criteria applicable to the operation of quadrupole mass filters. Generally, the “a” parameter is related to DC and the “q” parameter is related to RF. It may be stated that a bounded solution to the Mathieu equation corresponds to a finite displacement of an ion along the x or y axis where such an ion follows a trajectory that avoid colliding with rod surfaces and reaches the detector (e.g., passes through the quadrupole and is not filtered out). It may also be stated that an unbounded solution to the Mathieu equation describes the case where the radial displacement of the ion increases without bound and collides with rod surfaces and is thereby filtered out by the quadrupole to preclude further transmission of the ion through the quadrupole. In particular the reduced parameters “a” and “q” may be defined as:

aₓ=−a_{y}=(4zeU)/(m²r₀²) EQUATION B

qₓ=−q_{y}=(2zeV)/(m²r₀²) EQUATION C

In the above, “m” and “z” are, respectively, mass and charge for an ion. Ions for which there is a bounded solution correspond to stable trajectories in the quadrupole mass filter. In other words, such ions having stable trajectories are those trajectories which allow an ion to be transmitted through the quadrupole (such as from ion source to detector) without collision with the rod surfaces of the quadrupole.

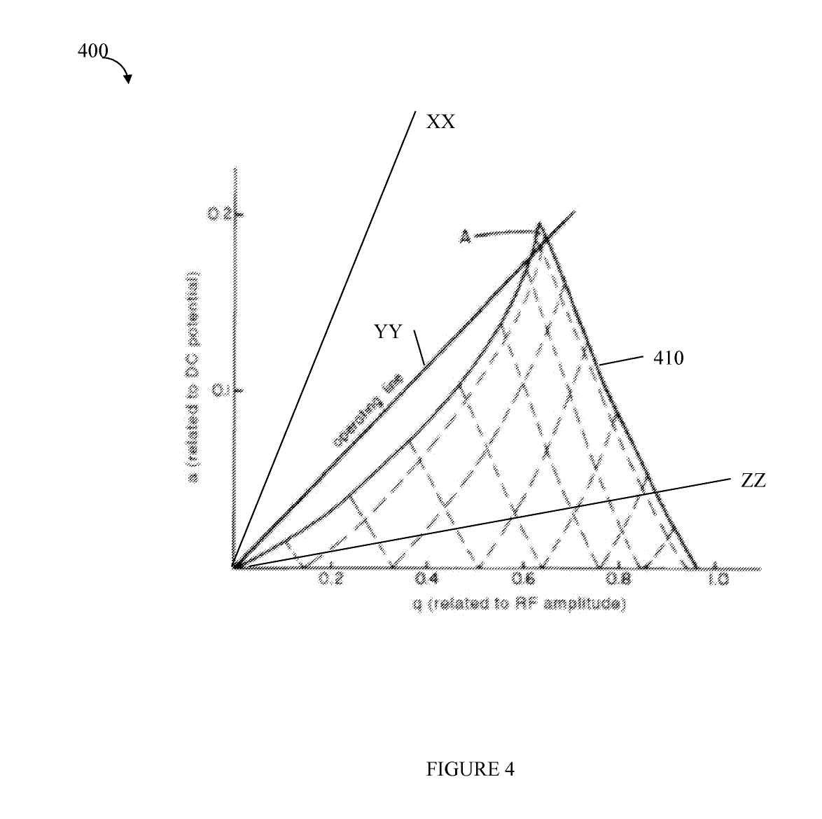

With reference to FIG. 4, shown is a stability diagram graphically illustrating how the complex array of parameters (e, ω, r₀, m, U and V) affecting the motion of an ion through the quadrupole mass filter can be reduced to a two-dimensional problem involving only the a and q parameters. Stable coordinates of a and q space are those included in the hashed triangular region denoted by 410. Line YY may denote a first operating line or mass scan line. If the quadrupole operates with a DC potential and RF amplitude that define the line YY, only those ions with m/z values defined in the tip portion A above the line YY have stable trajectories. In other words, with YY as the operating line for the quadrupole, only ions having a and q parameters that are within area 410 and also above the line YY pass through the quadrupole and have stable trajectories. In connection with the mass scan or operating line such as YY, this line represents the operation of the quadrupole by adjusting the RF and DC potentials in a fixed ratio. A complete mass spectrum may be obtained by adjusting or scanning the magnitude of RF and DC potentials through a range from a low or minimum value to a high or maximum value. Based on above equations, mass of an ion is inversely proportional to both “a” and “q” parameters for the ion.

If the DC/RF ratio, and also the a/q ratio, is adjusted to raise the operating line to XX rather than YY, no ions fall into the stability region 410 (e.g., no ion a and q parameters are within area 410) and also above the line XX thereby representing an operation of the quadrupole where no ions pass through (e.g., all ions are filtered). Thus, with the operating line YY as generally compared to other operating lines higher than YY, the resolving power of the MS increases but the sensitivity further decreases in that fewer ions fall into the stability region 410 and also have a and q parameter values above the operating line.

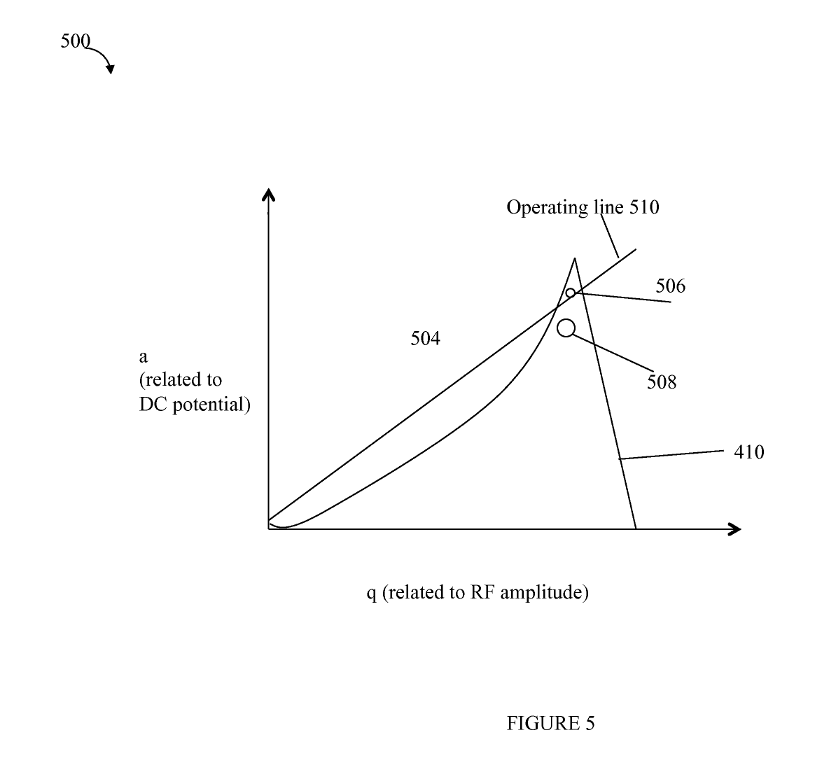

To further illustrate, reference is made to FIG. 5 which is an example illustrating ions 506 and 508 each having a and q parameter values in the stability region 410. However, in this case, only ion 506 but not 508 passes through the quadrupole since ion 506 has a and q parameter values which are both in region 410 and also above the line 510. In contrast, ion 508 has a and q parameter values within region 410 but not above the line 510.

A quadrupole may also operate in RF-only mode where there is no DC potential meaning that all values for the “a” parameter for all ions=0 since U=0 as in the above equations. In this case, the operating line or mass scan line may be generally represented as a horizontal line along the x-axis. Thus, in a quadrupole without the supplemental RF potential described herein in following paragraphs in which there is only a primary RF and DC potential=0, the example 400 of FIG. 4 indicates that ions of all m/z values have stable trajectories and are transmitted through the quadrupole filter.

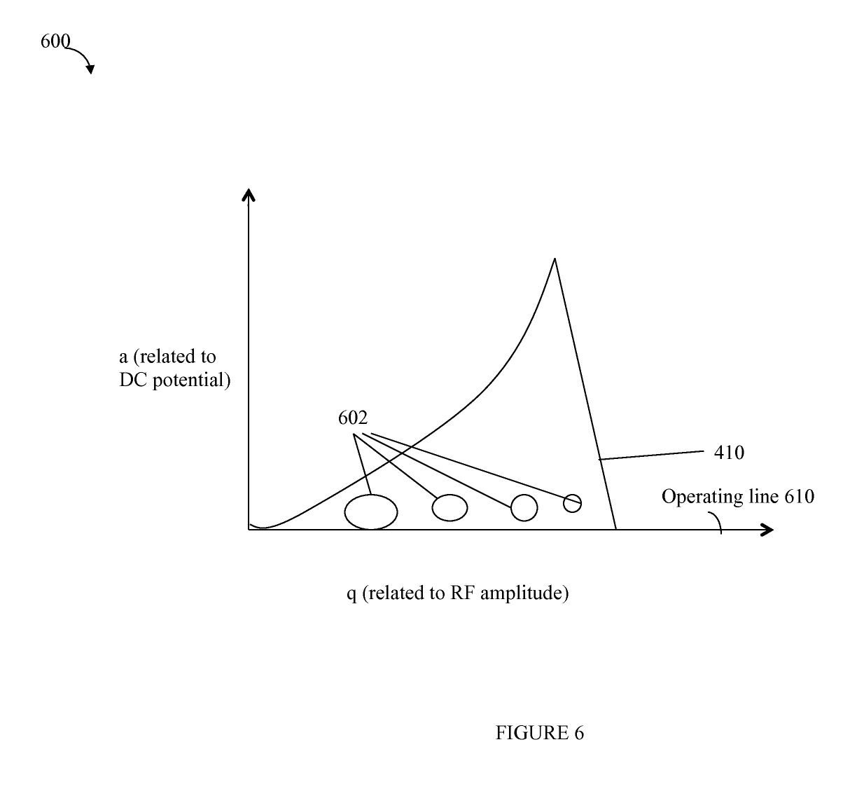

To further illustrate, reference is made to FIG. 6 which is an example illustrating ions 602 having a and q parameter values in the stability region 410. As noted above when operating in RF-only mode without the supplemental RF potential using techniques herein, the operating line for the quadrupole may be represented by 610 thereby indicating that all ions 602 pass through the quadrupole.

In one embodiment in accordance with techniques herein, the quadrupole (e.g., such as a Q1 and/or Q3 quadrupole in a triple quadrupole MS arrangement) may operate in RF-only mode such that there is no DC potential, the primary or driving RF potential applied to the quadrupole rod surfaces has an amplitude based on an operating line or mass scan line that corresponds to a horizontal line along the x-axis in the example 400 (e.g. operating line 610 of FIG. 6), and additionally, a supplemental RF potential having a notched waveform is also applied to the quadrupole rod surfaces. It should be noted that the primary, driving RF potential may operate at a fixed or constant frequency over time and over multiple scans and its amplitude may be adjusted based on the RF-only operating or mass scan line (horizontal line on x-axis of FIG. 4). As will be described in more detail, the notched waveform of the supplemental RF potential may have multiple frequency-based notches where each such notch omits one or more selected frequencies to allow a corresponding ion of a different mass or m/z to pass through the quadrupole. The supplemental RF potential at a point in time has a waveform including a plurality of frequencies with particular frequencies excluded or “notched out” in order to selectively allow ions to pass through the quadrupole. Thus, the particular frequencies which are notched out at a point in time are determined based on the ions to be selectively allowed to pass through the quadrupole (e.g., not filtered out). Suitable amplitudes are accordingly determined for the selected frequencies omitted from the supplemental RF waveform.

The particular frequencies omitted from the notched waveform may be based on the resonant frequencies of the ions that pass through the quadrupole.

Thus, the notched waveform of the supplemental RF potential at a single point in time has multiple notches, each notch including one or more omitted frequencies corresponding to (and determined based on) the mass or m/z of an ion to pass through the quadrupole.

It should be noted that although it may be preferred in some embodiments in accordance with techniques herein to operate with a DC potential=0 (e.g., in RF-only mode), the quadrupole may also operate in accordance with techniques herein in non-RF only mode (e.g., where DC potential is not equal to 0) using a supplemental RF having a notched waveform and the primary RF. In such embodiments, the primary RF and DC may have values selected and adjusted as described above such as in connection with FIGS. 4 and 5 for a particular operating line or mass scan line as may be applicable in an embodiment. For example, in such embodiments, the DC/RF ratio may be held during operation of the instrument as the amplitude(s) of the DC and/or primary RF are varied during operation with the additionally applied supplemental RF potential having a notched waveform with multiple frequency-based notches.

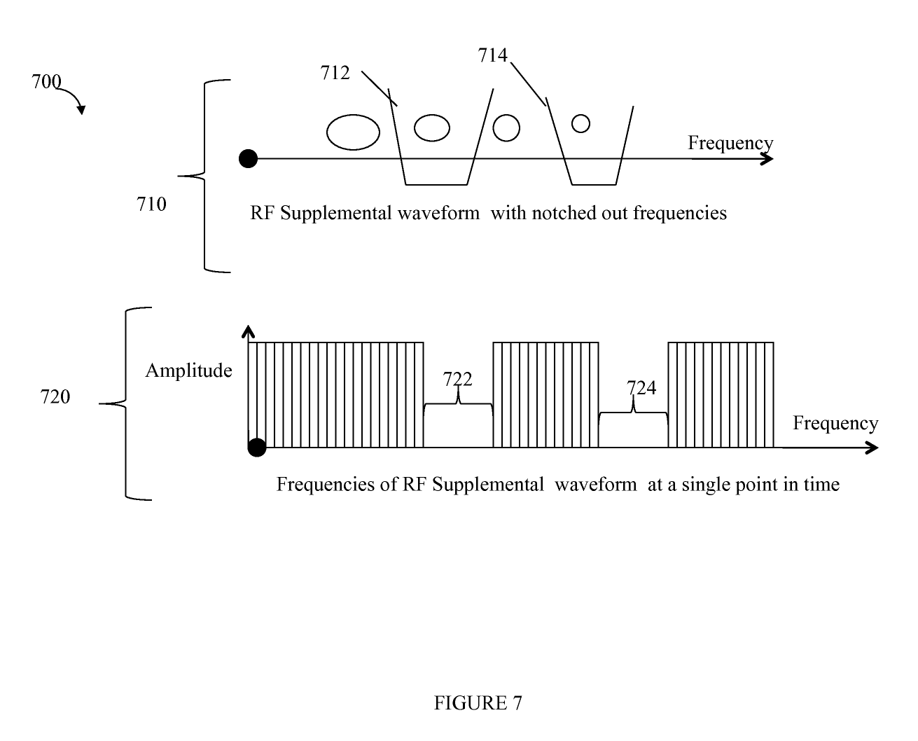

Referring to FIG. 7, shown is an example of a notched waveform of a supplemental RF potential that may be applied to the quadrupole at a single point in time in addition to the primary RF and DC potential in an embodiment in accordance with techniques herein. Element 710 presents a graphical illustration of the notches 712 and 714 that may be included in the supplemental RF waveform comprising a plurality of frequencies and additionally including multiple frequency-based notches to “notch out” or exclude frequencies from the supplemental RF waveform. As illustrated, notch 712 excludes one or more frequencies in order to allow the ion included in 712 with a particular mass or m/z to pass through the quadrupole. Similarly, notch 714 excludes one or more frequencies in order to allow the ion included in 742 having a particular mass or m/z to pass through the quadrupole.

Element 720 illustrates an example of a notched waveform for the supplemental RF. The waveform of 720 includes a first notch 722 of one or more omitted frequencies to perform mass isolation or filtering allowing the ion of 712 to selectively pass through the quadrupole. The waveform of 720 also includes a second notch 724 of one or more omitted frequencies to perform mass isolation or filtering allowing the ion of 714 to selectively pass through the quadrupole. It should be noted that the waveform of 720 represents the waveform at a single point in time including a plurality of different frequencies with particular ones omitted to allow multiple ions having different mass values to pass through the quadrupole.

As described elsewhere herein, for an ion of a particular mass or m/z, a frequency may be determined indicating a frequency to be omitted from the RF supplemental notched waveform in order to allow the ion to pass through the quadrupole. With the addition of the RF supplemental notched waveform, undesired ion masses to filtered out are energized by the waveform. However, the notch (i.e., a frequency range) in which there are no frequencies of significant intensity, does not energize the ions of interest which are therefore allowed to pass through out of the quadrupole.

In one embodiment in accordance with techniques herein when operating the quadrupole in RF-only mode, the DC potential=0 and the primary RF potential is held at a constant frequency while the primary RF potential may have its amplitude vary over time. In this case, the notched waveform of the supplemental RF potential is also applied to the quadrupole to selectively allow multiple ions to pass through the quadrupole, where each such ion has a different mass or m/z and an omitted frequency of the notched waveform corresponds to each such ion. The amplitude of the primary driving RF that drives the quadrupole rod set may have an amplitude determined based on the mass scan or operating line. When operating in RF-only mode, this mass scan line may be represented as in 610 of FIG. 6. When the quadrupole in accordance with techniques herein with the supplemental RF notched waveform does not operate in RF-only mode and the DC potential is non-zero, the primary RF and DC potential may be held at a constant ratio in operation as described above based on a particular mass scan line. For example, with reference back to FIG. 4, the operating line or mass scan line may be ZZ, YY or some other line originating from origin (e.g., the starting coordinates (0,0)). For example, the DC potential may be held as a fixed fraction of the primary RF potential. The primary RF potential may be held at a constant frequency during operation of the instrument during different scans at different points in time.

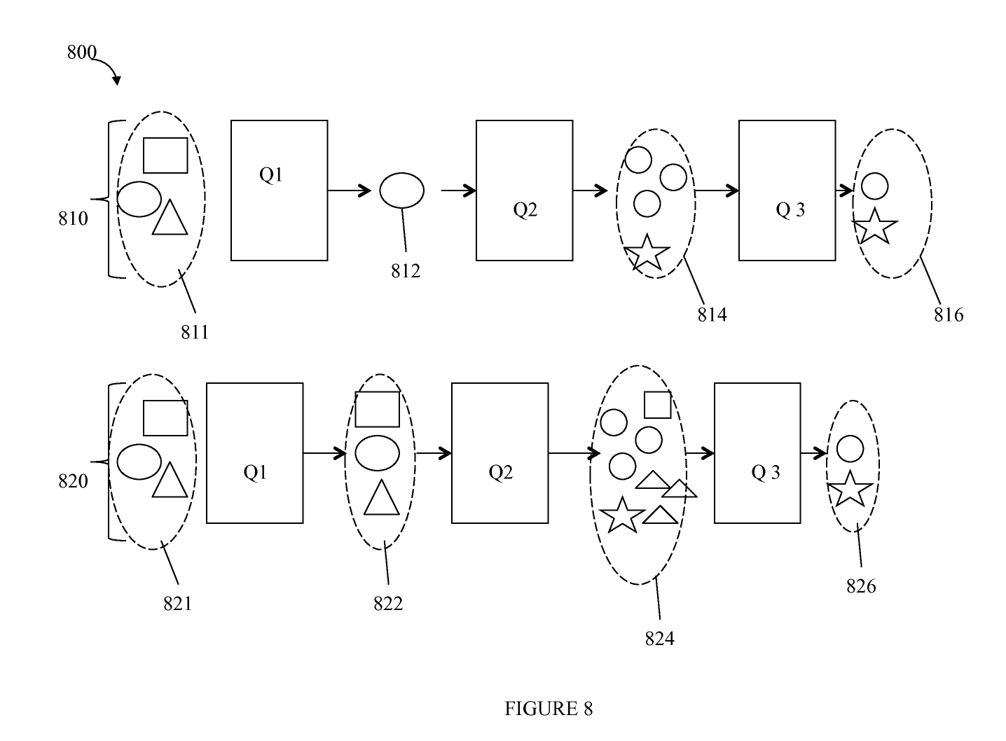

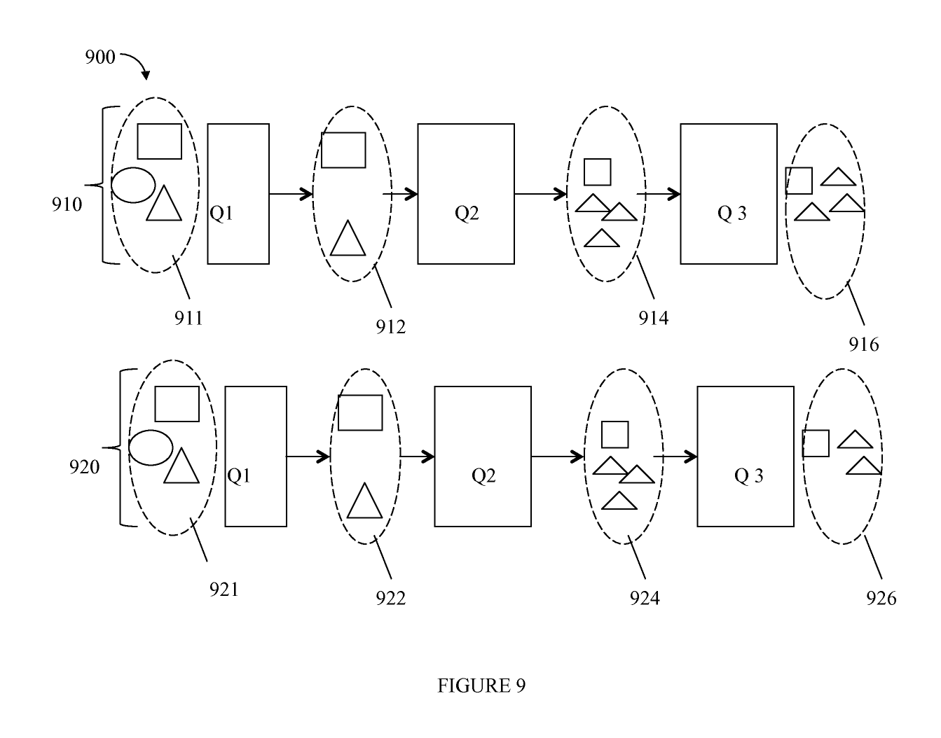

With reference to FIG. 8, illustrated are exemplary applications of the techniques herein in a triple quadrupole MS. In FIGS. 8 and 9, the three quadrupoles of the MS are denoted Q1, Q2 and Q3. In the first example 810, Q1 and Q3 perform mass filtering and Q2 performs fragmentation. Ions 811 are filtered by Q1 so that only a single precursor ion 812 passes through which is then fragmented by Q2 resulting in product or fragment ions 814 which are fragments of the precursor ion 812. Q3 also operates as a mass filter but includes a supplemental RF potential with a notched waveform as described herein to selectively allow two fragments of 814 to pass through Q3. Element 816 represents the selected fragments allowed to pass through Q3 for the particular single precursor ion 812. Thus, Q1 may operate without application of a supplemental RF including multiple notches. Rather, Q1 may operate to allow only a single selected precursor to pass through. Q3 may operate in accordance with techniques herein with an additional supplement RF having a notched waveform to selectively allow two fragments of 816 to pass through Q3. The example 810 illustrates one usage of the quadrupole operating in accordance with techniques herein to allow more than one product or fragment ion to pass through at a same time thereby increasing the sensitivity of the MRM (multiple reaction monitoring) scan.

As a further example, consider a protein, molecule, analyte or other compound. A first protein may be identified by detection of a first precursor P1 and fragment or product ions F1, F2 and F3. A second protein may be identified by detection of a second precursor P2 and its associated fragment or product ions F1, FA and FB. As such, when determining whether a compound contains a first protein or otherwise performing quantification with respect to the first protein, it may be desirable to filter out those fragments which are not known to be unique or distinguishing to the first protein (e.g., filter out F1) and utilize F2 and F3. In a similar manner, when determining whether a compound contains the second protein or otherwise performing quantification with respect to the second protein, it may be desirable to filter out those fragments which are not known to be unique or distinguishing to the second protein (e.g., filter out F1) and utilize FA and FB. The foregoing may be performed to selectively utilize only those fragments for quantification which are known to be associated with particular molecules.

The example 810 illustrates one way in which the techniques herein may be utilized in connection with Q3 when operating the triple quadrupole MS in a particular way. As an additional example, consider the illustration 820. Element 821 represents a set of precursor ions and Q1 allows all precursor ions of 821 to pass through as 822. For example, Q1 may operate in RF-only mode without a supplemental RF potential. The precursor ions 822 are fragmented by Q2 producing fragments 824. Q3 may operate in accordance with techniques herein with an additional supplement RF having a notched waveform to selectively filter the fragments of 824 thereby allowing the two fragments of 826 to pass through Q3. The example 820 illustrates a use of the techniques herein, for example, where the selected fragment or product ions of interest may be known but not the precursor ion.

Referring to FIG. 9, illustrated are additional exemplary applications of the techniques herein in a triple quadrupole MS. In the example 910, element 911 represents a set of precursor ions which are mass filtered by Q1 to selectively allow two precursors through. Q1 may operate in accordance with techniques herein with an additional supplement RF having a notched waveform to selectively allow two precursor ions of 911 to pass through Q1. The two precursors that pass through Q1 are represented by 912 and are then fragmented by Q2 to generate product or fragment ions 914. Q3 then operates to allow all such fragments of 914 to pass through as represented by 916. The example 910 may be used, for example, where Q1 operating in accordance with techniques herein selectively allows particular known precursors to pass through. The example 910 may be used to determine what fragments are produced from the selected precursors of 912.

In yet another example 920, element 921 represents a set of precursor ions which are mass filtered by Q1 to selectively allow two precursors through. Q1 may operate in accordance with techniques herein with an additional supplement RF having a notched waveform to selectively allow two precursor ions of 921 to pass through Q1. The two precursors that pass through Q1 are represented by 922 and are then fragmented by Q2 to generate product or fragment ions 924. Q3 then also operates in accordance with techniques herein with an additional supplement RF having a notched waveform to selectively allow three fragments of 924 to pass through as represented by 926.

It should be noted that the techniques herein may be used to selectively allow a molecule of a particular single charge state (e.g., single charged, double charged or triple charged) to pass through and exclude other charge states of the same molecule.

The techniques herein may be used in an embodiment with a quadrupole that performs mass filtering using a supplemental RF potential having a notched waveform with multiple notches. The notched waveform may be characterized as including frequencies corresponding to those ions having masses to be filtered out and not allowed to pass through the quadrupole. The notched waveform includes frequency-based notches or holes in which each notch excludes one or more frequencies corresponding to those ions having masses that pass through the quadrupole and are not filtered out. The quadrupole mass analyzer in accordance with techniques herein acts as a mass-selective filter designed to pass unfiltered ions through and may also be referred to as a transmission quadrupole.

Described above are embodiments with a quadrupole operating as a mass filter and applying thereto a supplemental RF potential having a notched waveform with a plurality of notches to allow a plurality of selected ions, each of a different mass or m/z, to pass through. The quadrupole operating as a mass filter in accordance with techniques herein may be more generally referred to as an electrode-based device. As will be appreciated by those of ordinary skill in the art, the techniques herein may be utilized in connection with more generally any other suitable electrode-based devices besides the quadrupole. For example, the techniques herein may be used with an electrode-based device that is any of a multi-pole device (e.g. include multiple poles or rods), and a quadrupole device (e.g., as described above using 4 rods or poles).

It should be noted that any suitable electrical means, wiring, coils, circuitry, components and the like, may be used as the one or more components for supplying and/or generating a first RF potential, a DC potential, and a supplemental RF potential applied to a quadrupole or other electrode-based device in an embodiment in accordance with techniques herein. Selected values of the first RF potential, DC potential and/or supplemental RF potential as supplied and/or generated by such one or more components for use with techniques herein may be controlled, such as using instrument control software for the mass spectrometer.

It should be noted that, the techniques described in preceding paragraphs and exemplary embodiments may be used with generally any molecule and compound such as, for example, peptides, proteins, metabolites, lipids, pesticides, natural products, and the like.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. An apparatus for performing mass spectrometry comprising:
a quadrupole that performs mass filtering for selectively filtering ions; and
one or more components that generate a first RF potential, a DC potential, and a supplemental RF potential applied to said quadrupole, said supplemental RF potential having a corresponding multiple notched waveform having a plurality of corresponding frequencies thereby allowing a plurality of ions to pass through said quadrupole at a same time, each of said plurality of corresponding frequencies corresponding to a notch in the waveform allowing one of said plurality of ions of a different mass or m/z to pass through said quadrupole for processing by another component.

2. The apparatus of claim 1, wherein said mass spectrometer comprises three quadrupoles and said quadrupole is a first of the three quadrupoles coupled to a second of the quadrupoles.

3. The apparatus of claim 2, wherein the second quadrupole fragments at least a portion of selected ions that pass through/are emitted from the first quadrupole, said second quadrupole emitting fragment ions.

4. The apparatus of claim 3, wherein the second quadrupole is coupled to a third of the three quadrupoles, and wherein said third quadrupole performs mass filtering for selectively filtering fragment ions emitted from said second quadrupole, and the apparatus further comprises:
one or more components that generate a second RF potential, a second DC potential, and a second supplemental RF potential applied to said third quadrupole, said second supplemental RF potential having a corresponding multiple notched waveform having a plurality of corresponding frequencies thereby allowing a plurality of the fragment ions to pass through said third quadrupole at a same time, each of said plurality of corresponding frequencies corresponding to a notch in the waveform allowing one of said plurality of fragment ions of a different mass or m/z to pass through said third quadrupole for processing by another component.

5. The apparatus of claim 1, wherein said quadrupole filters fragmented ions received from an upstream component, each of said corresponding frequencies corresponding to a notch in the waveform allowing a different one of said fragmented ions of a different mass or m/z to pass through said quadrupole.

6. The apparatus of claim 1, wherein the DC potential is zero.

7. The apparatus of claim 6, wherein for a plurality of scans taken at a plurality of points in time, for each of the plurality of scans, the first RF potential having an amplitude that drives the quadrupole is held at a constant frequency, the DC potential amplitude is held at zero, and wherein amplitude of the first RF potential is varied.

8. The apparatus of claim 1, wherein the plurality of ions pass through pass said quadrupole in a single scan.

9. An apparatus for performing mass spectrometry comprising:
an electrode-based device that performs mass filtering of ions; and
one or more components that generate a first RF potential, a DC potential, and a supplemental RF potential applied to said electrode-based device, said supplemental RF potential having a corresponding multiple notched waveform having a plurality of corresponding frequencies thereby allowing a plurality of ions to pass through said electrode-based device at a same time, each of said plurality of corresponding frequencies corresponding to a notch in the waveform allowing one of said plurality of ions of a different mass or m/z to selectively pass through said electrode-based device for subsequent processing by another component.

10. The apparatus of claim 9, wherein said electrode-based device is any of multi-pole device and a quadrupole device.

11. The apparatus of claim 9, wherein said DC potential is zero.

12. The apparatus of claim 9, wherein the plurality of ions are selected fragmented ions and the electrode-based device performs filtering to allow the selected fragmented ions to pass through said electrode-based device to a detector.

13. The apparatus of claim 12, wherein the selected fragments ions are associated with a precursor ion selectively emitted by a second electrode-based device upstream from the electrode-based device.

14. The apparatus of claim 13, wherein the apparatus further comprises:
one or more components that generate a second RF potential, a second DC potential, and a second supplemental RF potential applied to said second electrode-based device, said second supplemental RF potential having a corresponding multiple notched waveform having a plurality of corresponding frequencies thereby allowing a plurality of precursor ions to pass through said quadrupole at a same time, each of said plurality of corresponding frequencies corresponding to a notch in the waveform allowing one of said plurality of precursor ions of a different mass or m/z to pass through said second electrode-based device for processing by another component.

15. A method of performing mass spectrometry comprising:
performing first mass filtering of precursor ions using a first quadrupole to selectively allow a first precursor to pass through the first quadrupole for processing by second quadrupole;
performing, using the second quadrupole, fragmentation of the first precursor ion emitted from the first quadrupole, said fragmentation producing a plurality of fragment ions associated with the first precursor ion; and
performing second mass filtering using a third quadrupole to selectively allow at least two of said plurality of fragment ions to pass through said third quadrupole at a same time for a same scan, wherein said third quadrupole has applied thereto a first RF potential, a supplementary RF potential and a DC potential, wherein the DC potential is zero and the supplementary RF potential has a corresponding waveform comprising a plurality of notches therein, each of said plurality of notches corresponding to a different frequency allowing a different one of said at least two fragment ions having a different mass or m/z than others of said at least two fragment ions to pass through said third quadrupole at a same time for a same scan.

16. A method for performing mass spectrometry comprising:
applying a first RF potential, a DC potential, and a supplemental RF potential to an electrode-based device of a mass spectrometer, said supplemental RF potential having a corresponding multiple notched waveform having a plurality of corresponding frequencies thereby allowing a plurality of ions to pass through said electrode-based device at a same time, each of said plurality of corresponding frequencies corresponding to a notch in the waveform allowing one of said plurality of ions of a different mass or m/z to pass through said electrode-based device for processing by another component; and
performing mass filtering for selectively filtering ions using said electrode-based device.

17. The method of claim 16, said mass spectrometer is used to perform the mass spectrometry and comprises three quadrupoles, and said electrode-based device is a first of the three quadrupoles coupled to a second of the quadrupoles.

18. The method of claim 17, wherein the second quadrupole fragments at least a portion of selected ions that pass through/are emitted from the first quadrupole, said second quadrupole emitting fragment ions.

19. The method of claim 18, wherein the second quadrupole is coupled to a third of the three quadrupoles, and wherein said third quadrupole performs mass filtering for selectively filtering fragment ions emitted from said second quadrupole, and wherein a second RF potential, a second DC potential, and a second supplemental RF potential are applied to said third quadrupole, said second supplemental RF potential having a corresponding multiple notched waveform having a plurality of corresponding frequencies thereby allowing a plurality of the fragment ions to pass through said third quadrupole at a same time, each of said plurality of corresponding frequencies corresponding to a notch in the waveform allowing one of said plurality of fragment ions of a different mass or m/z to pass through said third quadrupole for processing by another component.

20. The method of claim 16, wherein said electrode-based device is a multi-pole device that filters fragmented ions received from an upstream component or device, each of said corresponding frequencies corresponding to a notch in the waveform allowing a different one of said fragmented ions of a different mass or m/z to pass through said electrode-based device.

21. The method of claim 1, wherein the DC potential is zero.

22. The method of claim 21, wherein for a plurality of scans taken at a plurality of points in time, for each of the plurality of scans, the first RF potential having an amplitude that drives the quadrupole is held at a constant frequency, the DC potential amplitude is held at zero, and wherein amplitude of the first RF potential is varied.
